(19) United States
(12) Patent Application Publication
(10) Pub. No.: US 2015/0224509 A1
(43) Pub. Date: Aug. 13, 2015

(54) GRAIN MILL LINER ASSEMBLY

(71) Applicant: Kennametal Inc., Latrobe, PA (US)

(72) Inventors: Hugo Serrano, Lowell, AR (US); J. Denny Robertson, Bella Vista, AR (US); William H. Pierce, Rogers, AR (US)

(73) Assignee: Kennametal Inc., Latrobe, PA (US)

(21) Appl. No.: 14/178,911

(22) Filed: Feb. 12, 2014

(51) Int. Cl. B02C 15/00; B02C 11/00

(52) U.S. Cl. CPC B02C 15/003; B02C 11/00

(57) ABSTRACT

A grain mill liner assembly includes a generally circular support member having an outer surface and an inner surface, a plurality of gear teeth inserts spaced about the inner surface of the support member, and a plurality of retainer elements spaced about the inner surface of the support member and configured to be removably attached to the support member. Each retainer element engages adjoining gear teeth inserts for securing the gear teeth inserts to the support member.

### BACKGROUND OF THE INVENTION

The present invention relates to a grain mill liner assembly and, more particularly, relates to gear teeth insert for a grain mill liner assembly.

Many forms of grain mills are generally known for milling or grinding various types of grains such as corn, wheat, barley, oats or rice. One particular form of grain mill includes a fixed outer liner having integrally formed gear teeth facing inward and spaced apart from a rotatable inner grinding wheel also having gear teeth that do not engage the outer wheel teeth, but rather grinds or crushes the grain material between the two opposing sets of gear teeth. Over time, the outer wheel gear teeth, which are typically formed of a cast iron material, wear and need to be replaced. However, because the gear teeth are integrally formed with the outer wheel, the entire assembly needs to be replaced which has been found to be a timely and expensive process.

Accordingly, there has been identified a need for an improved grain mill liner that overcomes limitations, shortcomings and disadvantages of known grain mill assemblies. There also has been identified a need for an improved outer grain mill liner that overcomes limitations, shortcomings and disadvantages of known grain mill liners.

### SUMMARY OF THE INVENTION

In accordance with an aspect of the invention, a grain mill liner assembly includes a generally circular support member having an outer surface and an inner surface, a plurality of gear teeth inserts spaced about the inner surface of the support member, and a plurality of retainer elements spaced about the inner surface of the support member and configured to be removably attached to the support member. Each retainer element engages adjoining gear teeth inserts for securing the gear teeth inserts to the support member.

In accordance with another aspect of the invention, a grain mill liner assembly includes a generally circular support member having an outer surface and an inner surface. The grain mill liner assembly also includes a plurality of gear teeth inserts spaced about the inner surface of the support member and removably secured to the support member, wherein each of the plurality of gear teeth inserts includes a top surface, a first side that is generally planar and slopes outwardly away from the top surface towards the inner surface of the support member, and a second side that is generally planar and slopes outwardly away from the top surface towards the inner surface of the support member. The grain mill liner assembly further includes a plurality of retainer elements spaced about the inner surface of the support member and configured to be removably attached to the support member, wherein each of the plurality of retainer elements includes a top surface, an opposing bottom surface and first and second sides extending therebetween such that the first and second sides of each of the plurality of retainer elements are configured for engagement with one of the first side or second side of the adjacent gear teeth inserts for securing the gear teeth inserts to the support member.

In accordance with another aspect of the invention, a gear tooth insert for removably securing to a grain mill liner assembly includes a top portion, an opposing bottom portion, a first side that is generally planar and slopes outwardly away from the top portion towards the bottom portion, and a second side that is generally planar and slopes outwardly away from the top portion towards the bottom portion.

These and other aspects of the present invention will be more fully understood following a review of this specification and drawings.

### BRIEF DESCRIPTION OF THE DRAWINGS

FIG. 1 is an isometric view of grain mill liner assembly, in accordance with an aspect of the invention.

FIG. 2 is an enlarged, partial isometric view of an inner portion of the grain mill liner assembly illustrated in FIG. 1, in accordance with an aspect of the invention.

FIG. 3 is an enlarged, partial isometric view of an outer portion of the grain mill liner assembly illustrated in FIG. 1, in accordance with an aspect of the invention.

FIG. 4 is an isometric view of a retainer element, in accordance with an aspect of the invention.

FIG. 5 is an exploded isometric view of the retainer element shown in FIG. 4, in accordance with an aspect of the invention.

FIG. 6 is an isometric view of an additional retainer element, in accordance with an aspect of the invention.

FIG. 7 is an isometric view of a gear tooth insert, in accordance with an aspect of the invention.

FIG. 8 is an enlarged, partial isometric view of another inner portion of a grain mill liner assembly, in accordance with another aspect of the invention.

FIG. 8A is a sectional view taken along line 8A-8A of FIG. 8, in accordance with an aspect of the invention.

FIG. 9 is a partial elevational view showing a grain mill assembly, in accordance with an aspect of the invention.

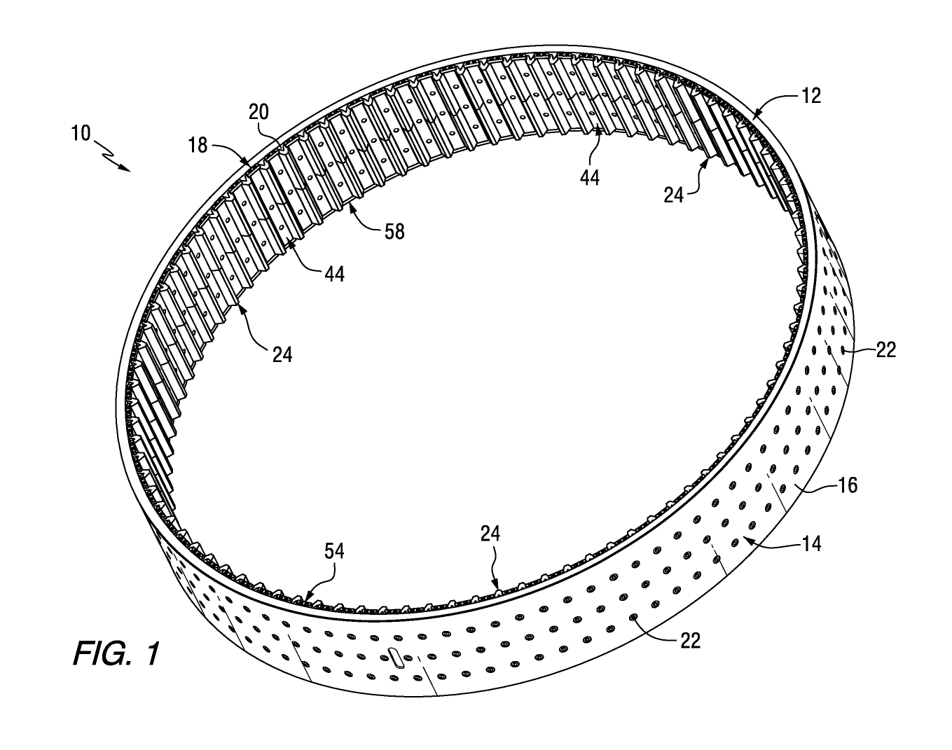

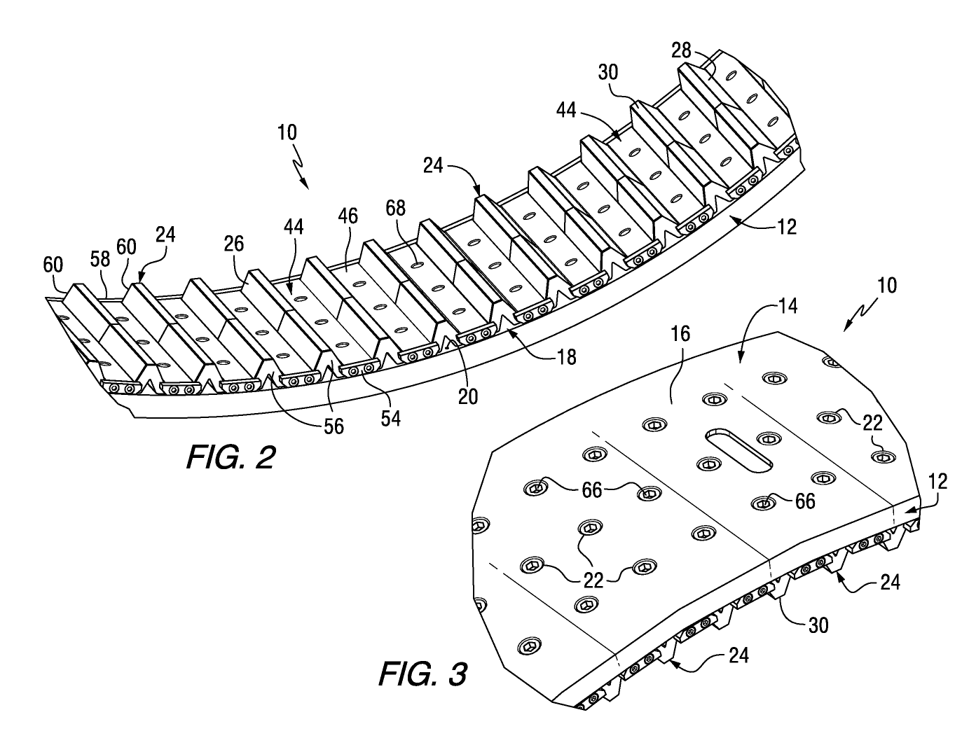

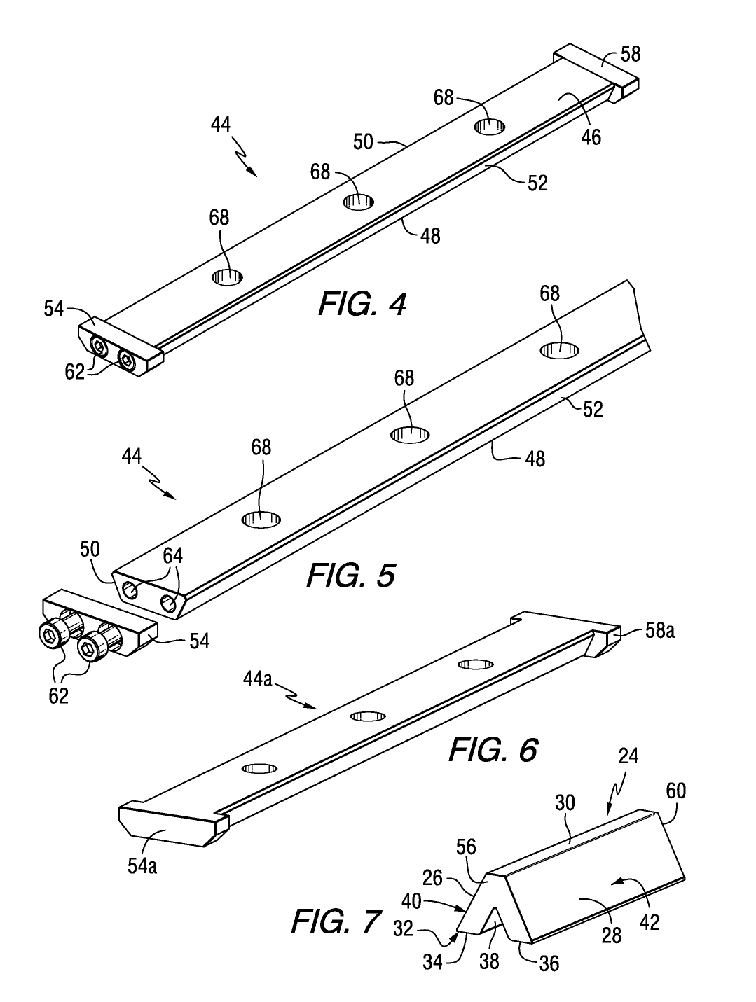

### DETAILED DESCRIPTION

Referring now to the Figures, a grain mill liner assembly 10 includes a generally circular support member 12 with an outer portion 14 having an outer surface 16. The outer surface 16 may also be referred to as an outer diameter of the grain mill liner assembly 10. The support member 12 also includes an inner portion 18 having an inner surface 20. The inner surface 20 may also be referred to as an inner diameter of the grain mill liner assembly 10. The support member 12 also includes a plurality of holes 22 extending therethrough from the outer surface 16 to the inner surface 20.

The grain mill liner assembly 10 further includes a plurality of gear teeth inserts 24 spaced about the inner surface 20 of the support member 12. The plurality of gear teeth inserts 24 are configured to be removably secured to the support member 12, as will be explained in more detail herein. Thus, the plurality of gear teeth inserts 24 may be individually installed and replaced as needed following wear or mechanical failure of one or more of the plurality of gear teeth inserts 24. However, to minimize wear and/or mechanical failure the gear teeth inserts 24 are formed of a hard material such as, but not limited to, a cemented (cobalt) tungsten carbide material. In one aspect, the gear teeth inserts 24 are formed of a harder material than the support member 12 which may be formed of, for example, steel or like materials.

In accordance with an aspect of the invention, each of the plurality of gear teeth inserts 24 includes a first side 26, a second side 28 and a top surface 30 connecting the first side 26 and the second side 28 or extending between the first side 26 and the second side 28. In one aspect, the top surface 30 can be a generally flat or generally planar surface as illustrated, but could have other configurations such as, for example, be configured as an apex that culminates by the conversion or meeting of the first side 26 and the second side 28.

In addition, each of the plurality of gear teeth inserts 24 further includes a bottom surface 32 that is configured to contact or engage, either directly or indirectly, the inner surface 20 of the support member 12. In one aspect, the bottom surface 32 may include a first bottom portion 34 spaced apart from a second bottom portion 36 so as to form a void or gap 38 therebetween. This configuration results in the first side 26 and first bottom portion 34 forming a first leg member 40 of the gear tooth insert 24 and similarly the second side 28 and second bottom portion 36 forming a second leg member 42. Advantageously, this configuration of each the plurality of gear teeth inserts 24 serves to structurally strengthen each of the plurality of gear teeth inserts 24 while reducing the amount of material needed to form each of the plurality of gear teeth inserts 24 as a result of the gap 38.

In another aspect of the invention, for each of the plurality of gear teeth inserts 24 the first side 26 is generally planar and slopes generally outwardly away from the top surface 30 towards the bottom surface 32 and thus towards the inner surface 16 of the support member 12. Similarly, for each of the plurality of gear teeth inserts 24 the second side 28 is generally planar and slopes generally outwardly away from the top surface 30 towards the bottom surface 32 and thus towards the inner surface 16 of the support member 12.

The grain mill liner assembly 10 further includes a plurality of retainer elements 44 spaced about and/or adjacent to the inner surface 16 of the support member 12 and configured to be removably attached to the support member 12. In accordance with an aspect of the invention, advantageously each retainer element 44 is configured to contact or engage adjoining gear teeth inserts 24 for securing the gear teeth inserts 24 to the support member 12.

In one aspect, each of the plurality of retainer elements 44 includes a top surface 46, an opposing bottom surface 48, and a first side 50 and second side 52 extending therebetween. In another aspect, the first and second sides 50, 52 of each of the plurality of retainer elements 44 are configured for engagement or contact, either directly or indirectly, with one of the first side 26 or second side 28 of the gear teeth inserts 24 for securing the gear teeth inserts 24 to the support member 12. In yet another aspect of the invention, the first and second sides 50, 52 of each of the plurality of retainer elements 44 are generally planar and slope generally inwardly from the top surface 46 to the bottom surface 48.

In accordance with another aspect of the invention, each of the plurality of retainer elements 44 can include a first end cap 54 configured for engaging first ends 56 of adjacent gear teeth inserts 24 and a second end cap 58 configured for engaging second ends 60 of adjacent gear teeth inserts 24. The first and second end caps 54, 58 prevent lateral or side-to-side movement of the gear teeth inserts 24 once secured to the inner surface 16 of the support member 12.

In one aspect, at least one of the first end cap 54 and the second end cap 58 are removably attached to the retainer element 44 by, for example, bolts 62 that pass therethrough for receipt in apertures 64 (see FIG. 5). Alternatively, a first end cap 54a and second end cap 58a may be integrally formed with the retainer element 44a and thus not removably attached (see FIG. 6).

The grain mill liner assembly 10 further includes means for removably attaching each of the plurality of retainer elements 44 to the support member 12 so as to clamp each of the plurality of gear teeth inserts 24 to the support member 12. In one aspect, the means for removably attaching may include bolts 66 that pass through the holes 22 in the support member and are received in apertures 68 formed in the retainer elements 44.

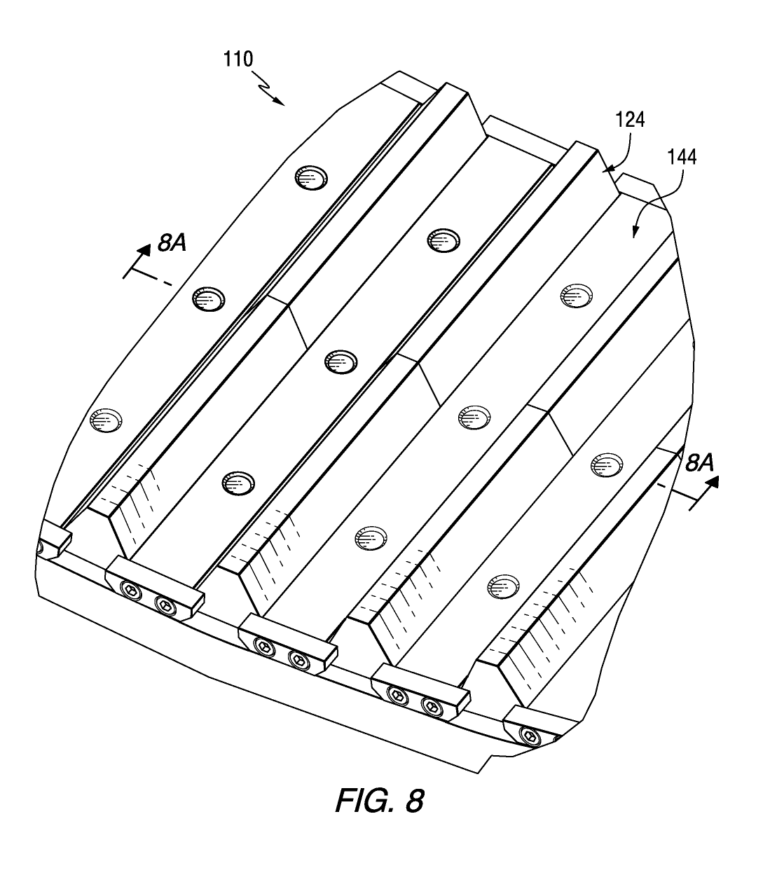

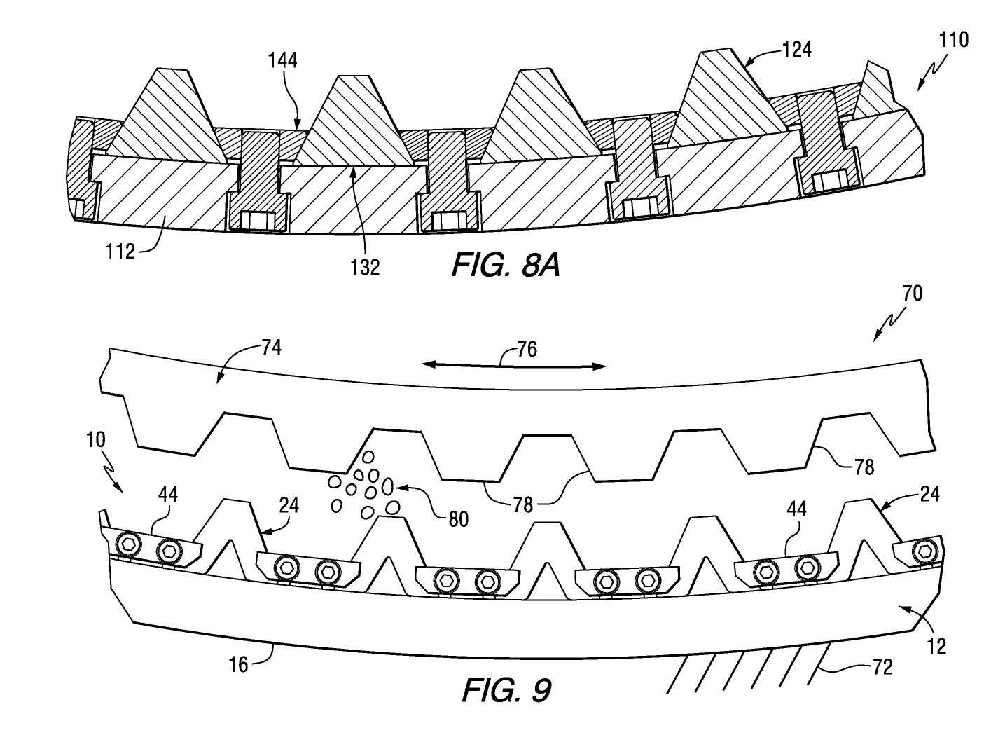

FIGS. 8 and 8a illustrate an additional grain mill liner assembly 110 having a differently configured or shaped plurality of gear teeth inserts 124 that have a continuous bottom surface 132 for contacting or engaging the inner surface 112. Otherwise, the grain mill liner assembly 110 is similar in structure and functionality to the grain mill liner assembly 10, as described herein, and includes a plurality of retainer elements 144 configured for removably securing or clamping the plurality of gear teeth inserts 124 to the inner surface 112.

FIG. 9 illustrates a grain mill assembly 70 employing the grain mill liner assembly 10 (which is typically fixed and does not rotate as shown at 72, but grain mill liner assembly 10 could be configured to rotate if desired) spaced apart from an inner grinding wheel 74 (which is rotatable as indicated by arrow 76) also having a plurality of gear teeth 78 that do not engage the plurality of gear teeth inserts 24, but rather grinds or crushes the grain material 80 between the two opposing sets of gear teeth 24 and 78.

Whereas particular aspects of this invention have been described above for purposes of illustration, it will be evident to those skilled in the art that numerous variations of the details of the present invention may be made without departing from the invention.

1. A grain mill liner assembly, comprising:
a generally circular support member having an outer surface and an inner surface;
a plurality of gear teeth inserts spaced about the inner surface of the support member; and
a plurality of retainer elements spaced about the inner surface of the support member and configured to be removably attached to the support member, wherein each retainer element engages adjoining gear teeth inserts for securing the gear teeth inserts to the support member.

2. The assembly of claim 1, wherein the plurality of gear teeth inserts are removably secured to the support member.

3. The assembly of claim 1, wherein the plurality of gear teeth inserts are formed of a cemented (cobalt) tungsten carbide material.

4. The assembly of claim 1, wherein each of the plurality of gear teeth inserts includes a first side, a second side and a top surface extending therebetween.

5. The assembly of claim 4, wherein the top surface is generally planar.

6. The assembly of claim 5, wherein the first side is generally planar and slopes outwardly away from the top surface towards the inner surface of the support member.

7. The assembly of claim 6, wherein the second side is generally planar and slopes outwardly away from the top surface towards the inner surface of the support member.

8. The assembly of claim 7, wherein each of the plurality of gear teeth inserts further includes a bottom surface that engages the inner surface of the support member.

9. The assembly of claim 1, wherein each of the plurality of retainer elements includes a top surface, an opposing bottom surface and first and second sides extending therebetween.

10. The assembly of claim 9, wherein the first and second sides of each of the plurality of retainer elements are configured for engagement with one of the first side or second side of the gear teeth inserts.

11. The assembly of claim 10, further including means for removably attaching each of the plurality of retainer elements to the support member so as to clamp each of the plurality of gear teeth inserts to the support member.

12. The assembly of claim 9, wherein the first and second sides of each of the plurality of retainer elements are generally planar and slope inwardly from the top surface to the bottom surface.

13. The assembly of claim 9, wherein each of the plurality of retainer elements includes a first end cap configured for engaging first ends of adjacent gear teeth inserts and a second end cap configured for engaging second ends of adjacent gear teeth inserts.

14. The assembly of claim 13, wherein at least one of the first end cap and the second end cap are removably attached to the retainer element.

15. A grain mill liner assembly, comprising:
a generally circular support member having an outer surface and an inner surface;
a plurality of gear teeth inserts spaced about the inner surface of the support member and removably secured to the support member, wherein each of the plurality of gear teeth inserts includes a top surface, a first side that is generally planar and slopes outwardly away from the top surface towards the inner surface of the support member, and a second side that is generally planar and slopes outwardly away from the top surface towards the inner surface of the support member; and
a plurality of retainer elements spaced about the inner surface of the support member and configured to be removably attached to the support member, wherein each of the plurality of retainer elements includes a top surface, an opposing bottom surface and first and second sides extending therebetween such that the first and second sides of each of the plurality of retainer elements are configured for engagement with one of the first side or second side of the adjacent gear teeth inserts for securing the gear teeth inserts to the support member.

16. The assembly of claim 15, further including means for removably attaching each of the plurality of retainer elements to the support member so as to clamp each of the plurality of gear teeth inserts to the support member.

17. The assembly of claim 15, wherein the first and second sides of each of the plurality of retainer elements are generally planar and slope inwardly from the top surface to the bottom surface.

18. The assembly of claim 15, wherein each of the plurality of retainer elements includes a first end cap configured for engaging first ends of adjacent gear teeth inserts and a second end cap configured for engaging second ends of adjacent gear teeth inserts.

19. The assembly of claim 15, wherein each of the plurality of gear teeth inserts further includes a bottom surface that engages the inner surface of the support member.

20. A gear tooth insert for removably securing to a grain mill liner assembly, the replaceable gear tooth insert comprising:
a top portion;
an opposing bottom portion;
a first side that is generally planar and slopes outwardly away from the top portion towards the bottom portion; and
a second side that is generally planar and slopes outwardly away from the top portion towards the bottom portion.
